(19) United States
(12) Patent Application Publication
(10) Pub. No.: US 2007/0180009 A1
(43) Pub. Date: Aug. 2, 2007

(54) RFID tag with random number generator having a noise-based input

(75) Inventor: Vadim Gutnik, Irvine, CA (US)

Correspondence Address: Edward W. Bulchis, Esq.;DORSEY & WHITNEY LLP, Suite 3400, 1420 Fifth Avenue, Seattle, WA, 98101, US

(73) Assignee: Impinj, Inc.

(21) Appl. No.: 11/355,665

(22) Filed: Feb. 15, 2006

Related U.S. Application Data
(60) Provisional application No. 60/667,180, filed on Mar. 30, 2005.

(51) Int. Cl. G06F 7/58; G06F 1/02

(52) U.S. Cl. 708/250; 340/10.1

(57) ABSTRACT

A random number generator for an RFID tag is described. In one such embodiment the random number generator includes a noise-controlled component comprising a noise source circuit that outputs a noise-based signal operable to generate random numbers from the noise-based signal. The noise-based signal is variable due to noise.

### CROSS-REFERENCE TO RELATED APPLICATION

This application claims the benefit of U.S. Provisional Application 60/667,180 entitled “RFID tags generating RNs based on noise”, filed Mar. 30, 2005, which is incorporated herein by reference.

### TECHNICAL FIELD

The present description addresses the field of Radio Frequency IDentification (RFID) systems, and more specifically, to RFID tags able to generate random numbers.

### BACKGROUND

Radio Frequency IDentification (RFID) systems typically include RFID tags and RFID readers (the latter are also known as RFID reader/writers or RFID interrogators). RFID systems can be used in many ways for locating and identifying objects to which the tags are attached. RFID systems are particularly useful in product-related and service-related industries for tracking large numbers of objects being processed, inventoried, or handled. In such cases, an RFID tag is usually attached to an individual item, or to its package.

In principle, RFID techniques entail using an RFID reader to interrogate one or more RFID tags. The reader transmitting a Radio Frequency (RF) wave performs the interrogation. A tag that senses the interrogating RF wave responds by transmitting back another RF wave. The tag generates the transmitted back RF wave either originally, or by reflecting back a portion of the interrogating RF wave in a process known as backscatter. Backscatter may take place in a number of ways.

The reflected back RF wave may further encode data stored internally in the tag, such as a number. The response is demodulated and decoded by the reader, which thereby identifies, counts, or otherwise interacts with the associated item. The decoded data can denote a serial number, a price, a date, a destination, other attribute(s), any combination of attributes, and so on.

An RFID tag typically includes an antenna system, a power management section, a radio section, and frequently a logical section, a memory, or both. In earlier RFID tags, the power management section included a energy storage device, such as a battery. RFID tags with an energy storage device are known as active tags. Advances in semiconductor technology have miniaturized the electronics so much that an RFID tag can be powered solely by the RF signal it receives. Such RFID tags do not include an energy storage device, and are called passive tags.

Some RFID communication protocols require tags to generate and use random numbers in some occasions. In other words, generate and use numbers that are different every time, and where one is not predictable from the previous ones.

A first such occasion can be when tags are being inventoried by an RFID reader, as can be required by a number of communication protocols. The random numbers assign each tag a number, as if by lottery. Then each tag responds only when its number comes up. This prevents many tags from responding at once, which in turn permits them to be accessed individually, while the other tags in the group are silent.

A second such occasion is for enhancing security. When it is a tag's turn to respond, it can give out its proposed “handle”, which operates as a custom nickname. Then the reader can use the nickname to call on the tag and receive its other information, such as an identifying code. This way the reader does not have to use the tag's code, for calling on it. This enhances security in the communication, in that a hypothetical rogue eavesdropping device need not just listen to the reader, but would also have to listen to the tag. This is harder on the rogue device, because the reader transmits with much more power than the tag.

A third such occasion is for encryption. A tag can use a random number as a key for encryption, when transmitting its own information. This would make it even harder on the hypothetical rogue eavesdropping device, even if it listened to the tag itself.

Generating random numbers is a challenge for RFID tags. Solutions given in the prior art include schemes where a sequence of random numbers is repeated, which is also known as pseudo-random number generation. These schemes can be ineffective when multiple tags are to be read at once, or if rogue readers become sophisticated. For example, knowing the structure of a tag circuit could reveal the pattern behind pseudo random numbers. True random numbers may perform better in these regards.

### SUMMARY

The invention overcomes the challenge of the prior art.

Random number generators for RFID tags and methods are described. Random numbers are generated based on noise, which is inherently unpredictable. In some such embodiments a noise-based signal is generated from noise, and then digitized.

These and other features and advantages of the invention will be better understood in view of the Detailed Description and drawings, in which:

### BRIEF DESCRIPTION OF THE DRAWINGS

FIG. 1 is a block diagram of an RFID system.

FIG. 2 is a diagram showing components of a passive RFID tag, such as the one shown in FIG. 1.

FIG. 3 is a block diagram of an implementation of an electrical circuit of a passive RFID tag, such as the one shown in FIG. 2.

FIG. 4 is a block diagram of a circuit embodiment of a noise-based random number generator (RNG) system for the processing block of FIG. 3.

FIG. 5 is a block diagram of an embodiment of a noise-based RNG for the RNG of FIG. 4 that uses a Pseudo Random Number Generator according to a first embodiment.

FIG. 6 is a block diagram of an embodiment of a noise-based RNG for the RNG of FIG. 4 that uses a Pseudo Random Number Generator according to a second embodiment.

FIG. 7 is a block diagram of a first particular embodiment of a noise-based RNG for the RNG of FIG. 6.

FIG. 8 is a block diagram of a second particular embodiment of a noise-based RNG for the RNG of FIG. 6.

FIG. 9 is a circuit schematic diagram of an embodiment of a noise-controlled component for the noise-controlled component of FIG. 4.

FIG. 10 is a circuit schematic diagram of another embodiment of a noise-controlled component for the noise-controlled component of FIG. 4.

FIG. 11 is a flow diagram 1100 illustrating a method for generating random binary digits from a noise-based signal.

FIG. 12 is a schematic diagram for a noise-sensitive circuit that generates random numbers according to an embodiment.

FIG. 13 is a flow diagram of a method for generating random numbers according to embodiments.

FIG. 14 is a diagram illustrating the effect of generating random numbers of one of the embodiments of the method of FIG. 13.

### DETAILED DESCRIPTION

Certain details are set forth below to provide a sufficient understanding of the invention. However, it will be clear to one skilled in the art that the invention may be practiced without these particular details. Moreover, the particular embodiments of the present invention described herein are provided by way of example and should not be used to limit the scope of the invention to these particular embodiments. In other instances, well-known circuits, control signals, timing protocols, and software operations have not been shown in detail in order to avoid unnecessarily obscuring the invention.

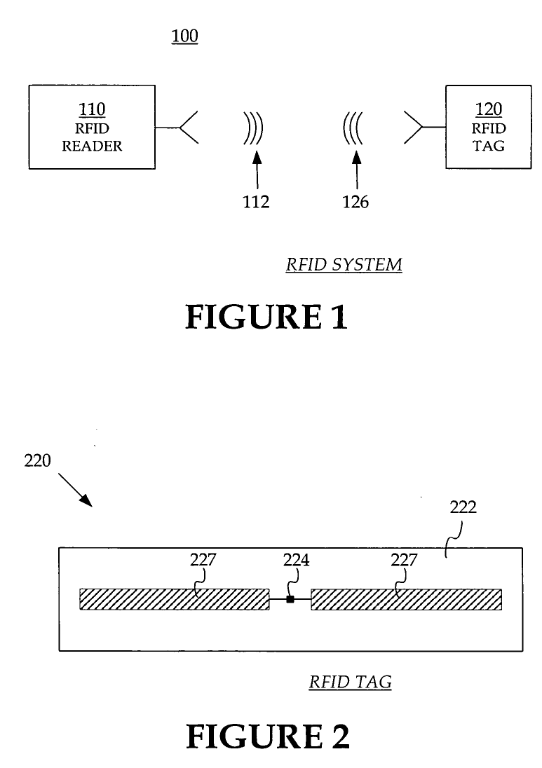

FIG. 1 is a diagram of a typical RFID system 100, incorporating aspects of the invention. An RFID reader 110 transmits an interrogating Radio Frequency (RF) wave 112. RFID tag 120 in the vicinity of RFID reader 110 may sense interrogating RF wave 112, and generate wave 126 in response. RFID reader 110 senses and interprets wave 126.

Reader 110 and tag 120 exchange data via wave 112 and wave 126. In a session of such an exchange, each encodes, modulates, and transmits data to the other, and each receives, demodulates, and decodes data from the other. The data is modulated onto, and decoded from, RF waveforms, as will be seen in more detail below.

Encoding the data can be performed in a number of different ways. For example, protocols are devised to communicate in terms of symbols, also called RFID symbols. A symbol for communicating can be a delimiter, a calibration symbol, and so on. Further symbols can be implemented for ultimately exchanging binary data, such as “0” and “1”, if that is desired.

Tag 120 can be a passive tag or an active tag, i.e. having its own power source. Where tag 120 is a passive tag, it is powered from wave 112.

FIG. 2 is a diagram of an RFID tag 220. Tag 220 is implemented as a passive tag, meaning it does not have its own power source. Much of what is described in this document, however, applies also to active tags.

Tag 220 is formed on a substantially planar inlay 222, which can be made in many ways known in the art. Tag 220 also includes two antenna segments 227, which are usually flat and attached to inlay 222. Antenna segments 227 are shown here forming a dipole, but many other embodiments using any number of antenna segments are possible.

Tag 220 also includes an electrical circuit, which is preferably implemented in an integrated circuit (IC) 224. IC 224 is also arranged on inlay 222, and electrically coupled to antenna segments 227. Only one method of coupling is shown, while many are possible.

In operation, a signal is received by antenna segments 227, and communicated to IC 224. IC 224 both harvests power, and responds if appropriate, based on the incoming signal and its internal state. In order to respond by replying, IC 224 modulates the reflectance of antenna segments 227, which generates the backscatter from a wave transmitted by the reader. Coupling together and uncoupling antenna segments 227 can modulate the reflectance, as can a variety of other means.

In the embodiment of FIG. 2, antenna segments 227 are separate from IC 224. In other embodiments, antenna segments may alternately be formed on IC 224, and so on.

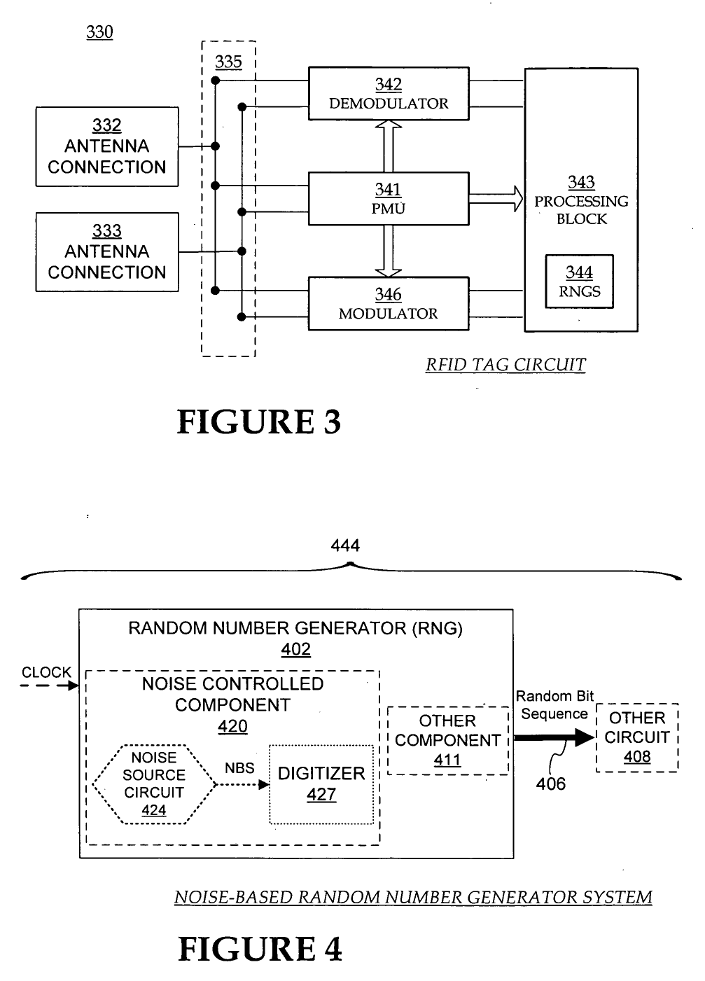

FIG. 3 is a block diagram of an electrical circuit 330. Circuit 330 may be formed in an IC of an RFID tag, such as IC 224 of FIG. 2. Circuit 330 has a number of main components that are described in this document. Circuit 330 may have a number of additional components from what is shown and described, or different components, depending on the exact implementation.

Circuit 330 includes at least two antenna connections 332, 333, which are suitable for coupling to one or more antenna segments (not shown in FIG. 3).

Antenna connections 332, 333 may be made in any suitable way, such as pads and so on. In a number of embodiments more than two antenna connections are used, especially in embodiments where more antenna segments are used.

Circuit 330 includes a section 335. Section 335 may be implemented as shown, for example as a group of nodes for proper routing of signals. In some embodiments, section 335 may be implemented otherwise, for example to include a receive/transmit switch that can route a signal, and so on.

Circuit 330 also includes a Power Management Unit (PMU) 341. PMU 341 may be implemented in any way known in the art, for harvesting raw RF power received via antenna connections 332, 333. In some embodiments, PMU 341 includes at least one rectifier, and so on.

In operation, an RF wave received via antenna connections 332, 333 becomes received by PMU 341 as a signal. The signal is used for both harvesting its power and decoding it.

Circuit 330 additionally includes a demodulator 342. Demodulator 342 demodulates an RF signal received via antenna connections 332, 333. Demodulator 342 may be implemented in any way known in the art, for example including an attenuator stage, amplifier stage, and so on.

Circuit 330 further includes a processing block 343. Processing block 343 receives the demodulated signal from demodulator 342, and may perform operations. In addition, it may generate an output signal for transmission.

Processing block 343 may be implemented in any way known in the art. For example, processing block 343 may include a number of components, such as a processor, a memory, a decoder, an encoder, and so on.

Processing block 343 also includes a random number generator system RNGS 344, which is noise-based. In other words, RNGS 344 outputs a sequence of random numbers, whose randomness is determined by electrical noise. RNGS 344 is described in more detail later in this document.

Circuit 330 additionally includes a modulator 346. Modulator 346 modulates an output signal generated by processing block 343. The modulated signal is transmitted by driving antenna connections 332, 333, and therefore driving the load presented by the coupled antenna segment or segments. Modulator 346 may be implemented in any way known in the art, for example including a driver stage, amplifier stage, and so on.

In one embodiment, demodulator 342 and modulator 346 may be combined in a single transceiver circuit. In another embodiment, modulator 346 may include a backscatter transmitter or an active transmitter. In yet other embodiments, demodulator 342 and modulator 346 are part of processing block 343.

It will be recognized at this juncture that circuit 330 can also be the circuit of an RFID reader according to the invention, without needing PMU 341. Indeed, an RFID reader can typically be powered differently, such as from a wall outlet, a battery, and so on. Additionally, when circuit 330 is configured as a reader, processing block 343 may have additional Inputs/Outputs (I/O) to a terminal, network, or other such devices or connections.

FIG. 4 is a block diagram of an embodiment of a noise-based random number generator system (RNGS) 444, such as RNGS 344 for the processing block of FIG. 3. RNGS 444 includes a random number generator (RNG) 402, and optionally other components, such as an other circuit 408 of a processing block, etc.

RNG 402 outputs a signal that encodes a sequence 406 of random numbers. For purposes of this document, the shorthand can be used that a random number generator outputs the random numbers themselves. In digital system implementations, the numbers are a series of digital bits 0 and 1.

The random number sequence 406 is received by the other circuit 408, which is suitable for using it for a number of processes, such as inventorying, enhanced security, encryption, and so on.

Optionally, RNG 402 may also receive a clock signal CLOCK. In one embodiment, outputting sequence 406 occurs responsive to the clock signal CLOCK.

RNG 402 includes a noise-controlled component 420, and optionally other components, such as other component 411. Component 420 generates a noise-dependent output. The signal that encodes sequence 406 of random numbers is formed from the noise-dependent output. In some embodiments, this noise-dependent output is a signal of a first series of random numbers. In some of those embodiments, this first series is sequence 406 itself.

Component 420 may be implemented in a number of ways. A number of those are described below.

In the embodiment of FIG. 4, component 420 includes a noise source circuit 424, which outputs a noise-based signal NBS. Signal NBS can be implemented in any number of ways, such as a voltage, a current, an electrical charge, etc. The value of signal NBS is variable due to noise, by appropriate construction of circuit 424. For example, noise source signal NBS can be variable due to electrical noise, thermally induced electrical noise, RF noise, shot noise, flicker noise, signal jitter, metastability, cosmic rays, radioactive decay, etc.

Component 420 also includes a digitizer 427, which may generate random numbers from noise-based signal NBS. Digitizer 427 may be made in any way known in the art. Some embodiments include analog to digital converters, comparators, logic devices such as logic gates configured to receive analog inputs, etc.

In some embodiments, a pseudo random number generator (PRNG) is also used in conjunction with the noise-controlled component 420 to generate the random numbers. A PRNG can be made in any way known in the art. One such way is, for example by feedback shift registers formed by series of flip-flops, e.g. a linear feedback shift register or a non-linear feedback shift register. Two such embodiments for using PRNGs are now described.

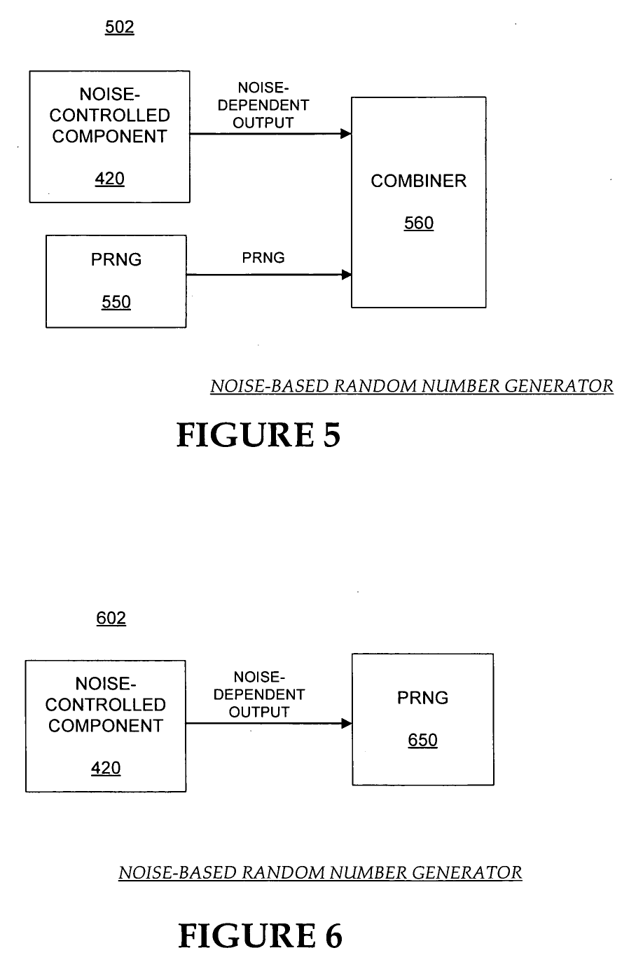

FIG. 5 is a block diagram of an embodiment of a noise-based RNG 502, such as RNG 402. Noise-controlled component 420 generates a noise-dependent output, as per the above. A PRNG 550 outputs a PRNG signal, which can be a series of pseudo-random numbers. In addition, a combiner 560 receives and combines the noise-dependent output of component 420 and the PRNG signal of PRNG 550. Combiner 560 may generate the sequence of random numbers directly, or some additional processing may be involved.

Combiner 560 can be made in any suitable way. One such way is with logic gates, such as for example using an XOR gate.

FIG. 6 is a block diagram of an embodiment of a noise-based RNG 602, such as RNG 402. Noise-controlled component 420 generates a noise-dependent output, as per the above. PRNG 650 outputs the random numbers in response to the noise-dependent output of component 420.

PRNG 650 may use the noise-dependent output of component 420 in a number of ways. Two such ways are described below.

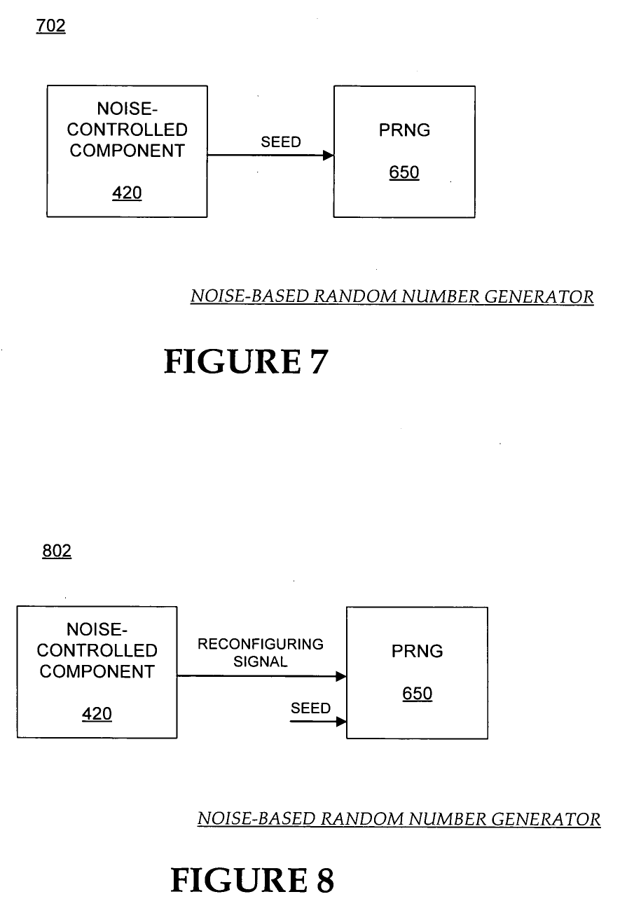

FIG. 7 is a block diagram of a first particular embodiment of a noise-based RNG 702, such as RNG 602. In the embodiment of FIG. 7, PRNG 650 generates the random numbers in response to receiving and using the noise-dependent output of component 420 as a seed. The seed can be an analog or digital, etc.

FIG. 8 is a block diagram of a second particular embodiment of a noise-based RNG 802, such as the RNG 602. PRNG 650 generates the random numbers in response to receiving and using the noise-dependent output of component 420 as a reconfiguring signal other than a seed. This can be implemented in a number of ways for example the reconfiguring signal could reconfigure the connections of PRNG 650 that is implemented as a feedback shift register and so on. Reconfiguring PRNG 650 adds further variation to PRNG 650, which further randomizes the generated sequence.

Noise controlled component 420 can be made in any suitable way. Two such ways are now described.

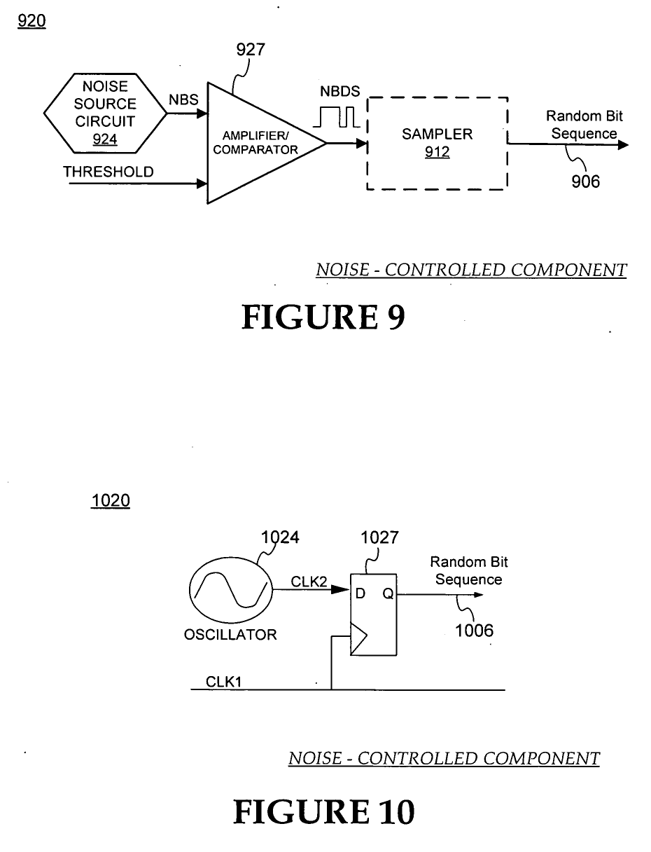

FIG. 9 is a circuit diagram of a noise-controlled component 920, which is a first example of an embodiment of noise-controlled component 420 of FIG. 4. In this first example, the noise-controlled component 920 includes a comparator 927 and optionally also a sampler 912.

Comparator 927 may be adapted to compare the variable noise-based signal NBS to a threshold, and to generate random numbers based on the comparison. Additionally, comparator 927 may also be adapted to amplify the output signal in cases where the noise signal may be small or difficult to detect.

The sampler 912 is a circuit that can optionally be configured to sample the variable noise-based digital signal NBDS generated by the comparator 927. While the sampler may be implemented by any means, one possible way is to sample the variable signal NBDS over time. Sampler 912 may then generate binary digits 906 based on the sampling.

FIG. 10 is a circuit diagram of a noise-controlled component 1020, which is a second example of an embodiment of noise-controlled component 420 of FIG. 4. The noise-controlled component 1020 in this second example includes an oscillator 1024 and at least one flip-flop 1027. While only one flip-flop 1027 is shown, more than one flip-flop could be used, and in any arrangement, such as a feedback shift register and so on.

In one embodiment at least one flip-flop 1027 receives a signal CLK2 from the oscillator 1024 and additionally another clock signal CLK1, to generate an unpredictable output of random sequence 1006. Sequence 1006 may optionally be further shifted through a linear feedback shift register for scrambling, and so on.

Oscillator 1024 may be implemented in any way known in the art. For example, it can be free running, and most free running oscillators are noisy to some extent. It is also preferred that CLK2 be not even be a small rational multiple or fraction of the CLK1 clock signal. For example, if CLK1 is at 1MHz, oscillator 1024 might be set such that CLK2 is 837 kHz, or 3.711 MHz, but not 1 MHz or 3 MHz or 500 kHz.

In addition, the rates of generation can be implemented in different ways. For example, random sequence 1006 may be generated at a first rate. Random numbers may then be shifted through the linear feedback shift register at a second rate. The second rate can be faster than the first rate.

As described in the- preceding embodiments, RNG 402 generates a sequence 406 of random numbers. This can be implemented in a number of ways, based on the noise-based signal NBS. In some instances the noise-based signal NBS is considered as generated by itself, and in others as added to a baseline signal. In the latter instances, the baseline signal is considered to be noise sensitive.

The noise-based signal NBS can be generated in a number of ways. One such way is for the NBS to be a voltage, which is generated at a sampling node of a circuit. Another way is for signal NBS to be a current, and so on.

Regardless of whether a voltage or a current, in some further embodiments, the noise-based signal NBS may additionally be adjusted in response to sequence 406 itself. This would ensure, for example, a sampling based on the noise source, and not any other interference. Such an example is now described.

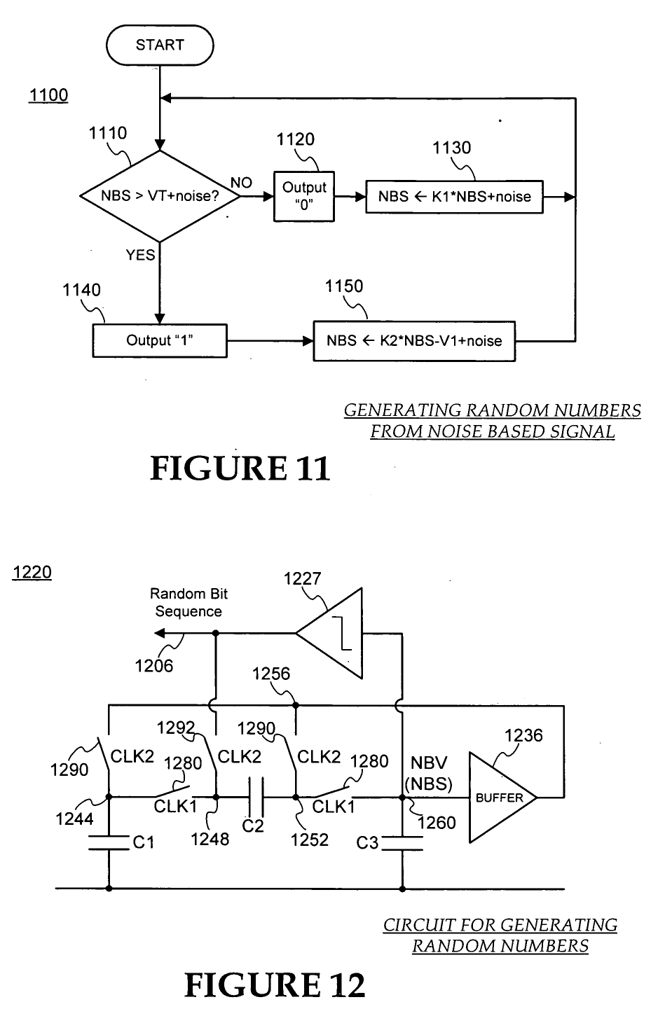

FIG. 11 is a flow diagram 1100 illustrating a method for generating random binary digits. The method includes generating a variable noise-based signal NBS. The noise-based signal NBS can be, for example, a voltage or a current. Then random numbers are generated based on the value of the signal NBS. In addition, signal NBS is then further adjusted according to the sampled noise input, as further described below.

It will be observed that, in many of the individual steps described below, noise is added inherently. These include sampling, multiplying or copying the NBS value, along with comparison. In fact, comparison itself has noise both in the threshold and in the circuits that do the comparison. This inherent inclusion of noise is underscored by explicitly including the word “noise” in some of the boxes below.

In diagram 1100, at step 1110 the signal NBS is compared to a suitable threshold signal VT, which is a voltage or a current depending on NBS. The comparison is used to determine what will be the next generated random digit, i.e. 0 or 1.

If at step 1110 signal NBS is less than threshold VT, then at a next step 1120, an output of 0 is generated. Then at an optional next step 1130 signal NBS is adjusted, e.g. by being multiplied by a parametric factor K1. Then execution returns to step 1110.

If at step 1110 signal NBS is greater than threshold VT, then at a next step 1140, an output of 1 is generated. Then at an optional next step 1150 signal NBS is adjusted, e.g. by being multiplied by a parametric factor K2, and reduced by a parametric signal V1. Then execution returns to step 1110.

Through this process, signal NBS undergoes different values that depend on noise. The parameters K1, K2, and V1 can be adjusted so that these values are above and below VT for approximately equal times. Alternative embodiments may include maintaining the voltage of the variable signal NBS within a minimum and maximum value as needed for generating random numbers.

FIG. 12 is a schematic diagram of a noise-sensitive circuit 1220 that generates random numbers. Circuit 1220 can implement a process for generating random numbers, such as the process of diagram 1100.

Circuit 1220 is a switched capacitor circuit. It includes a capacitor C2 between nodes 1248, 1252. A first switch 1280 is provided between node 1248 and a node 1244, and a second switch 1280 is provided between node 1252 and a sampling node 1260. Switches 1280 are turned on and off, for example according to a first clock CLK1. It need not be the same clock for both, and its period can be variable.

The whole operation, including the charging and discharging capacitor C2 generates a noise-based voltage NBV at a sampling node 1260. Noise-based voltage NBV operates as the above described noise-based signal NBS.

A comparator 1227 samples noise-based voltage NBV, and accordingly generates signals that encode a Random Bit Sequence 1206. The bit is generated according to the result of the comparison. As implemented here, the threshold is set at half the power-supply voltage. In general, the threshold can be any of a range of values dictated by the capacitor ratios. Different combinations of capacitor value ratios and thresholds will change the performance of the circuit; particularly poor choices will make the circuit generate non-random numbers (generally all 0s or all 1s).

In addition, the signals that encode sequence 1206 are used to charge (or not charge) capacitor C2 at node 1248, via a switch 1292.

Additional components are provided for operation of circuit 1220. It should be kept in mind that their values can be adjusted to affect the generation of sequence 1206, similarly to how parameters K1, K2 and Vi can be adjusted in flow diagram 1100 above.

Circuit 1220 includes capacitors C1, C3 between a ground and nodes 1244, 1260 respectively. In addition, a buffer 1236 buffers noise-based voltage NBV, and provides a buffered output signal to nodes 1244, 1256, via switches 1290. Switches 1290, and also switch 1292, can operate from the same clock CLK2, although that is not necessary. Equally, the period of clock CLK2 is another adjustable parameter, as per the above.

It will be further appreciated that sequence 1206 can be a long string of unpredictable digits. A problem is that the first few of these digits can be deterministic, i.e. the same every time, until the effect of noise takes over and makes them truly random. Noise can come from the operation of the components themselves, such as switches 1280, 1290, and 1292, and also from the comparator, buffer, and power supply, cosmic rays, etc.

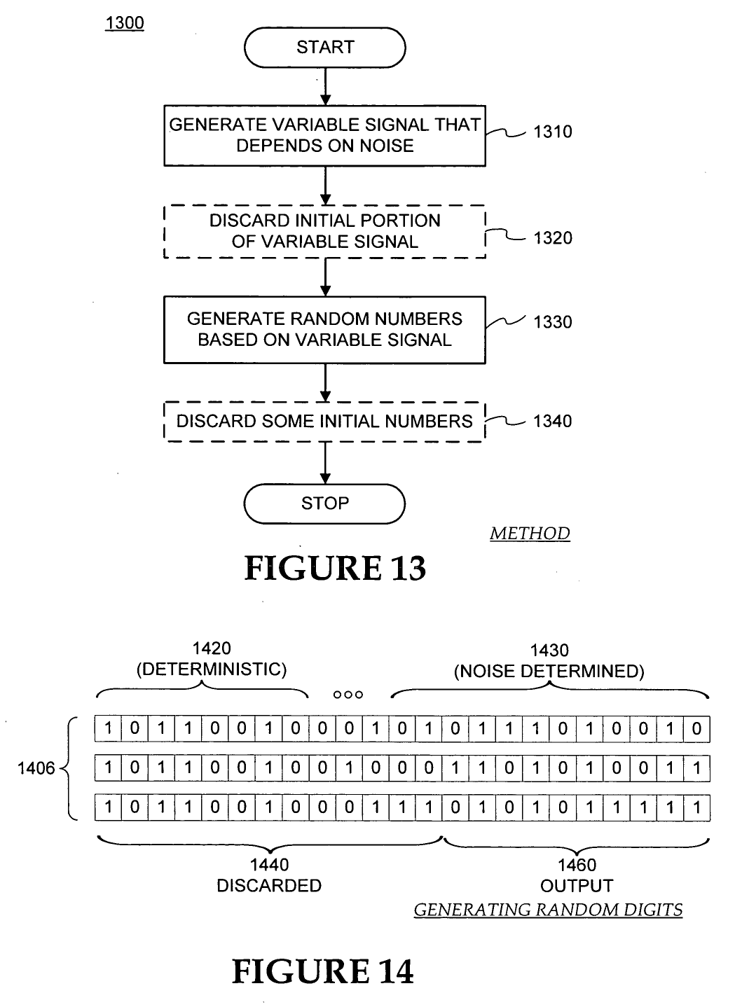

FIG. 13 is a flow diagram 1300 for a method of generating random numbers. The method of diagram 1300 may be practiced in a number of ways, such as the ways described in the previous embodiments.

At step 1310 a variable noise-based signal NBS is generated. Then at step 1330 random numbers are generated based on signal NBS.

The random numbers may be generated by any suitable method, including the methods described above. Additionally, the random numbers may be scrambled to further randomize the output sequence, as previously mentioned.

As described above, there may be the problem that the initial numbers are more deterministic, before the effects of noise take over to truly generate random numbers. This can be addressed in a number of ways, which involve discarding something generated initially. Discarding can be timed to take place over a number of clock cycles, and so on. As for what to discard, two examples are described below.

At an optional intermediate step 1320, an initial portion of signal NBS is discarded. This will prevent generating random numbers from that portion of the signal, which could be deterministic.

At an alternate optional intermediate step 1340, some of the initial generated numbers are themselves discarded. An example is shown below.

FIG. 14 is a diagram illustrating an effect of discarding, so as to correct for deterministically generated numbers. Three possible series 1406 are shown, each generated by the same process. Their first few digits 1420 are deterministically determined, before the effects of noise take over. As such, they are the same in every one of the series, and therefore not necessarily truly random. Later occurring digits 1430, however, are purely noise determined.

In the embodiments where discarding is described above, digits 1440 can be discarded. This is either by discarding the digits, or the signal that generated them. Then the output digits 1460 can be presented as the random numbers.

For discarding to work better, digits 1440 should be generated quickly, so that digits 1460 can be the output. This is not a problem with the above described embodiments, that can generate numbers quickly.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. A random number generator for an RFID tag circuit, comprising:
a noise-controlled component that comprises
a noise source circuit that outputs a noise-based signal, and
a digitizer operable to generate random numbers from the noise-based signal.

2. The generator of claim 1, wherein
the noise-based signal is variable due to at least one of electrical noise, thermally induced electrical noise, RF noise, shot noise, flicker noise, signal jitter, metastability, cosmic rays and radioactive decay.

3. The generator of claim 1, further comprising:
a pseudo random number generator (PRNG) operable in conjunction with the noise-controlled component to generate the random numbers.

4. The generator of claim 3, further comprising:
a combiner to output the random numbers in response to the output of the noise-controlled component and an output of the PRNG.

5. The generator of claim 4, wherein
the combiner comprises a logic gate.

6. The generator of claim 3, wherein
the PRNG is operable to generate the random numbers responsive to the output of the noise-controlled component.

7. The generator of claim 6, wherein
the PRNG is adapted to receive the output of the noise-controlled component as a seed.

8. The generator of claim 6, wherein
the PRNG is adapted to be reconfigured responsive to the output of the digitizer.

9. The circuit of claim 1, wherein the digitizer includes:
a sampling circuit operable to sample the noise-based signal.

10. The generator of claim 1, wherein the digitizer includes:
a comparator circuit operable to compare the noise-based signal to a threshold, and to generate random numbers based on the comparison.

11. The generator of claim 1, wherein the noise source circuit includes an oscillator.

12. The generator of claim 11, wherein the random number generator includes:
a flip-flop operable to generate random numbers responsive an output of the oscillator.

13. The generator of claim 1, wherein
the noise-based signal is a current.

14. The generator of claim 1, wherein
the noise-based signal is a noise-based voltage at a sampling node, and
the digitizer outputs a 1 or a 0 depending on the noise-based voltage.

15. The generator of claim 14, wherein
the noise-based voltage is further adjusted according to a noise input, responsive
to the digitizer outputting the 1 or the 0.

16. The generator of claim 14, wherein
the noise source circuit includes a switched capacitor circuit coupled to the sampling node and having switches operable to be clocked by at least one clock signal for adjusting the noise-based voltage.

17. An RFID tag, comprising: an integrated circuit which includes a random number generator that comprises:
means for generating a variable noise-based signal that depends on noise; and
means for generating random numbers based on the variable signal.

18. The tag of claim 17, wherein
the variable signal is a voltage signal.

19. The tag of claim 17, wherein
the variable signal is a current signal.

20. The tag of claim 17, wherein
the variable signal is variable due to at least one of electrical noise, thermally induced electrical noise, shot noise, flicker noise, signal jitter, metastability, cosmic rays and radioactive decay.

21. The tag of claim 17, wherein
the random numbers are generated by sampling the variable signal over time.

22. A method for an RFID tag, comprising:
generating a variable noise-based signal that depends on noise; and
generating random numbers based on the variable signal.

23. The method of claim 22, wherein
the variable signal is a voltage.

24. The method of claim 22, wherein
the variable signal is a current.

25. The method of claim 22, wherein
the variable signal is variable due to at least one of electrical noise, thermally induced electrical noise, shot noise, flicker noise, signal jitter, metastability, cosmic rays and radioactive decay.

26. The method of claim 22, wherein
the random numbers are generated by sampling the variable signal over time.

27. The method of claim 26, wherein
sampling comprises comparing the variable signal to a threshold.

28. The method of claim 26, wherein
the noise-based signal is further adjusted according to a noise input, responsive to the sampling.

29. The method of claim 22, further comprising:
scrambling the generated random numbers.

30. The method of claim 29, wherein
scrambling is performed by shifting the random numbers through a linear feedback shift register.

31. The method of claim 30, wherein
the random numbers are generated at a first rate, and
the random numbers are shifted through the linear feedback shift register at a second rate faster than the first rate.

32. The method of claim 29, wherein
the variable signal is a noisy clock signal.

33. The method of claim 22, further comprising:
discarding at least an initial portion of the variable signal without generating random numbers from it.

34. The method of claim 22, further comprising:
generating a series of numbers based on the variable signal; and
discarding at least some of the initial numbers of the series to output the random numbers.
